(19) United States
(12) Patent Application Publication
(10) Pub. No.: US 2008/0276199 A1
(43) Pub. Date: Nov. 6, 2008

(54) ITEM SELECTING DEVICE, ITEM SELECTING METHOD AND ITEM SELECTING PROGRAM

(76) Inventors: TORU HOSOGAI, Tokyo (JP); Katsuhito Takatsuki, Tokyo (JP); Hiroaki Yoshimura, Tokyo (JP); Teruaki Sasou, Tokyo (JP); Kanako Otsuji, Tokyo (JP); Takashi Akiu, Tokyo (JP)

Correspondence Address: NEC CORPORATION OF AMERICA, 6535 N. STATE HWY 161, IRVING, TX, 75039, US

(21) Appl. No.: 12/034,013

(22) Filed: Feb. 20, 2008

(30) Foreign Application Priority Data
Feb. 27, 2007 (JP) 2007-047034

(51) Int. Cl. G06F 3/048

(52) U.S. Cl. 715/841

(57) ABSTRACT

An item selecting device includes: a display controlling section for displaying a Venn diagram formed from subsets each of which indicates a selectable item on a display screen, wherein each of areas formed by the Venn diagram corresponds to an item group including at least one of the selectable item; a control section for inputting information of a designated area selected from the areas by an input device; and a selected item judging section for cancelling a designated item which is each of elements of the item group corresponding to the designated area from a selected item list when the designated item is set as an item already selected, and for adding the designated item to the selected item list when the designated item is not set as an item already selected. By this construction, the selected item can be easily changed.

This Application is based on Japanese Patent Application No.2007-047034, filed Feb. 27, 2007. The disclosure of the Japanese Patent Application is incorporated herein by reference.

1. Technical Field

The present invention relates to an item selecting technique for allowing a user to select a single item or a plurality of items from a plurality of selection candidate items.

2. Background Art

For demonstrating a technique of item selection relating to the present invention, an example of an item selecting device in a related art is explained below. FIGS. 1A and 1B show examples of screens displayed by an item selecting device in a related art. In FIG. 1A, item selecting buttons 101 to 103 are displayed on a screen. In FIG. 1B, check boxes 104 to 106 for selecting an item are displayed on a screen.

When selecting an item by using the item selecting device on which the items are displayed in the screen as shown in FIG. 1A, the user operates the button that corresponds to the item the user wants to select by using a mouse or the like. For example, the user operates two buttons 101 and 103 for selecting items X and Z.

When selecting an item by using the item selecting device on which the items are displayed in the screen as shown in FIG. 1B, the user checks a check box that corresponds to the item the user wants to select by using a mouse or the like. For example, the user checks two selection boxes 105 and 106 for selecting items Y and Z.

As described, with an item selecting device of the related art, it is necessary to perform selecting operations for a plurality of times when selecting a plurality of items.

Moreover, the item selection can be performed by using a Venn diagram, in which the operability is high compared to the above mentioned related arts. An example of such a technique is described in Japanese Laid-Open Patent Application JP-A-Heisei, 8-16607.

As shown in FIG. 2, an item selecting device employing a Venn diagram displays, on a screen, a Venn diagram where the whole selectable items “X, Y, Z” are considered as a universal set, each of the items “X”, “Y”, and “Z” is considered as a subset, and each subset is shown with a circle.

When selecting items by using the item selecting device on which the items are displayed in the screen as shown in FIG. 2, a user selects areas that correspond to the items the user wants to select. That is, when selecting a single item such as “X”, “Y”, or “Z”, the user selects an area 201, 202, or 203, respectively. When selecting two items such as “X and Y”, “Y and Z”, or “Z and X”, the user selects an area 204, 205, or 206, respectively. When selecting all the items “X and Y and Z”, the user selects an area 207.

In the meantime, when the user selects an area on the Venn diagram, a processing unit of the item selecting device judges that the item corresponding to the area is selected by the user. For example, when the area 201, 202, or 203 is selected, the processing unit judges that the item “X”, “Y”, or “Z” is selected, respectively. When the area 204, 205, or 206 is selected, the processing unit judges that the items “X and Y”, “Y and Z”, or “Z and X” are selected, respectively. When the area 207 is selected, the processing unit judges that the items “X and Y and Z” are selected.

### SUMMARY

With the above-described technique employing a Venn diagram, a plurality of items can be selected by a single selecting operation. Thus, it is possible to provide a high operability. However, with the item selecting device using the screen as shown in FIG. 2, if selected items are finalized by a single selecting operation, the selected items cannot be changed thereafter. For example, when the user mistakenly selects the area 207 even though the user actually wanted to select the items “X” and “Y”, the selected contents are finalized as “X and Y and Z”. Thus, the user needs to clear the selected contents once, and then perform a selecting operation again. Further, for example, when the user realizes that it is also necessary to select the item “Y” after making a selection of the item “X”, the user needs to clear the selected contents once, and then perform the selecting operation again. Furthermore, it is not possible to add or cancel an item while checking a combination of the items to be selected.

An exemplary object of the present invention therefore is to allow users to change the selection of items with a simple operation.

In an exemplary embodiment of the present invention, an item selecting device includes: a display controlling section configured to display a Venn diagram formed from a plurality of subsets each of which indicates a selectable item on a display screen, wherein each of a plurality of areas formed by the Venn diagram corresponds to an item group including at least one of the selectable item; a control section configured to input information of a designated area selected from the plurality of areas by an input device; and a selected item judging section configured to cancel a designated item which is each of elements of the item group corresponding to the designated area from a selected item list when the designated item is set as an item already selected, and to add the designated item to the selected item list when the designated item is not set as an item already selected.

According to the present invention, the selection of items can be changed by a simple operation, so that the operability can be improved. For example, canceling an item from selected items and adding a new item to the selected items can be performed by simply selecting an area on the Venn diagram. This makes it possible to achieve highly convenient operation. The reason for this is that the present invention includes selected item judging section which: recognizes all the selected items assigned within the area on the Venn diagram that is selected by the user through an input device; when there is an already-selected item within the recognized items, excludes that item from the selected items; and when there is an item that is not yet selected in the recognized items, adds that item to the selected items.

### BRIEF DESCRIPTION OF THE DRAWINGS

FIG. 1A is a view for describing a related art;

FIG. 1B is a view for describing a related art;

FIG. 2 is a view for describing another related art;

FIG. 3 shows an example of an embodiment the item selecting device according to the present invention;

FIG. 4 shows an example of the item selecting screen 21;

FIG. 5 shows an example of contents of the Venn diagram display information storage section 14;

FIG. 6 is a flowchart showing an example of processing executed by the control section 11;

FIG. 7 is a flowchart showing an example of processing executed by the selected item judging section 13;

FIG. 8 is a block diagram showing an example of a first example of an embodiment;

FIG. 9 is a view showing an example of a set menu selecting screen 71;

FIG. 10 is a block diagram showing an example of a second example of an embodiment; and

FIG. 11 is a view showing an example of the function selecting screen 91.

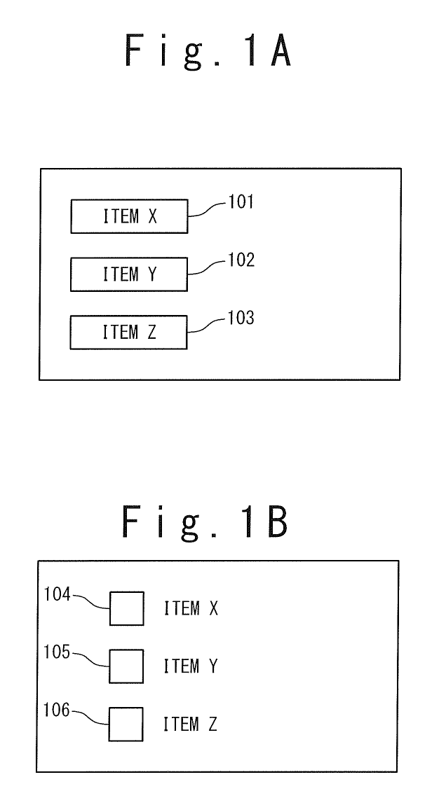

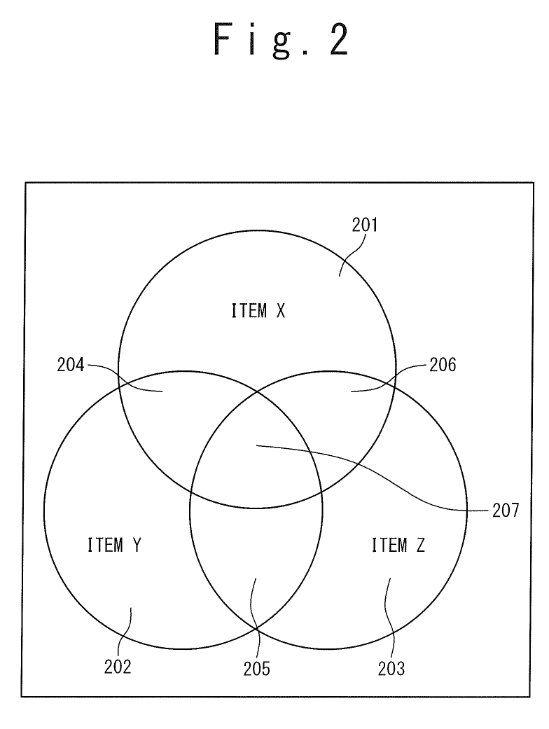

### EXEMPLARY EMBODIMENTS

Hereinafter, an item selecting device, item selecting method and item selecting program according to exemplary embodiments of the present invention will be described with reference to the attached drawings.

### Explanations on Structures of Exemplary Embodiments

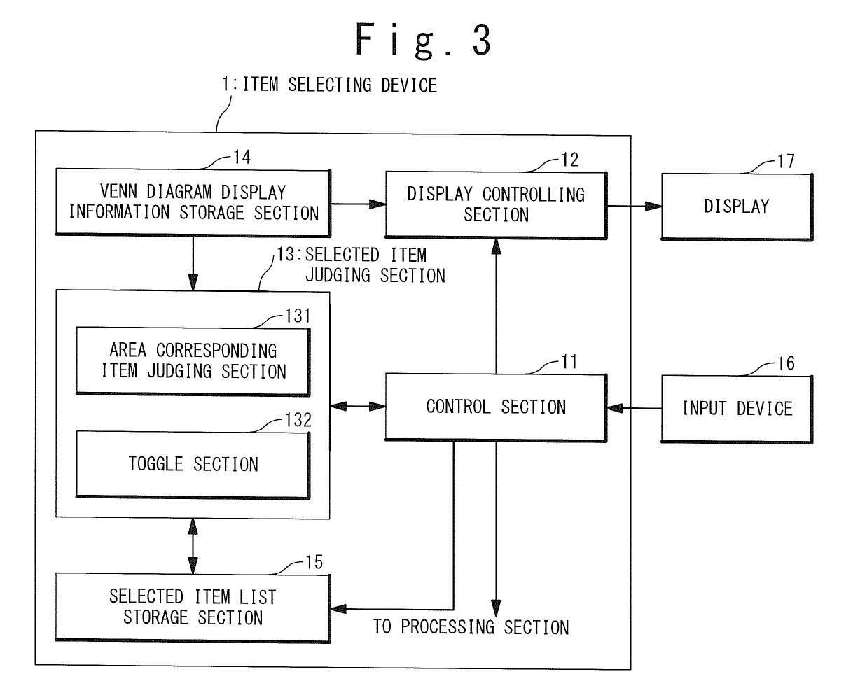

Referring to FIG. 3, an embodiment of the item selecting device 1 according to the present invention includes control section 11, display controlling section 12, selected item judging section 13, a Venn diagram display information storage section 14, a selected item list storage section 15, an input device 16 including a keyboard, a mouse and the like, and a display 17 such as an LCD.

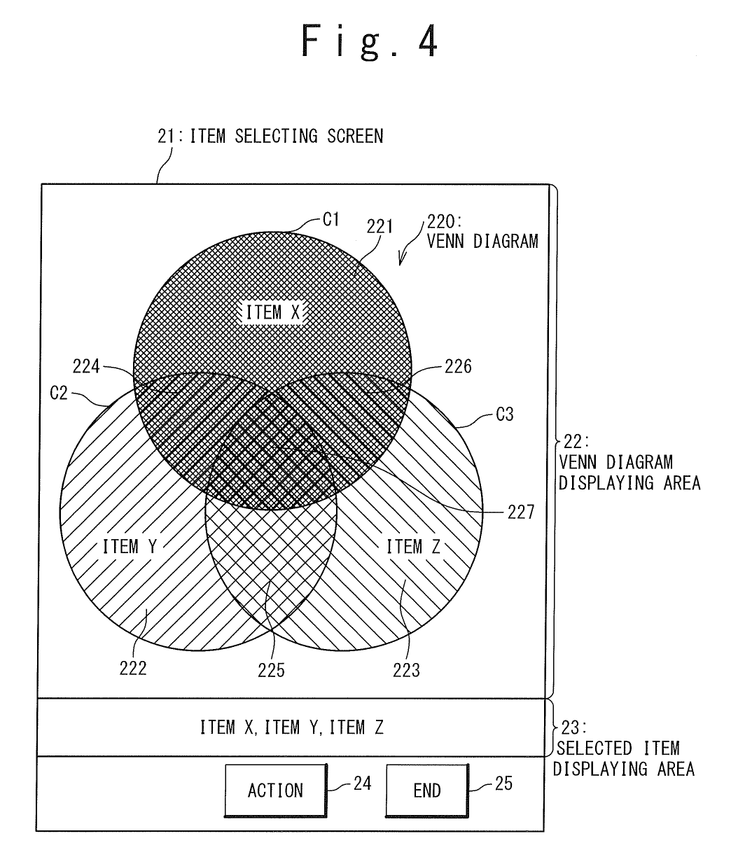

An item selecting screen 21 as shown in FIG. 4 is displayed on the display 17. A Venn diagram displaying area 22, a selected item displaying area 23, an action button 24, and an end button 25 are provided on the item selecting screen 21.

A Venn diagram 220 is displayed on the Venn diagram displaying area 22. In the Venn diagram 220, the whole selectable selection candidate items are set as a universal set, each of the selection candidate items is set as a subset, and each subset is drawn as a circle. The Venn diagram 220 shown in FIG. 4 is a diagram which shows items “X”, “Y”, “Z” as a universal set, and each of the items “X”, “Y”, “Z” as a subset with circles C1, C2, C3, respectively. The Venn diagram 220 is sectioned into areas 221, 222, 223 corresponding to the items “X”, “Y”, “Z”, areas 224, 225, 226 corresponding to items “X and Y”, “Y and Z”, “Z and X”, and an area 227 corresponding to “X and Y and Z”.

The display controlling section 12 has a function of displaying the item selecting screen 21 as shown in FIG. 4 on the display 17 in response to an item selecting screen display instruction from the control section 11. The display controlling section 12 displays on the item selecting screen 21 a Venn diagram based on Venn diagram information stored in the Venn display information storage section 14 and on the Venn diagram displaying area 22, and items included in the selected item display instruction supplied from the control section 11 on the selected item displaying area 23.

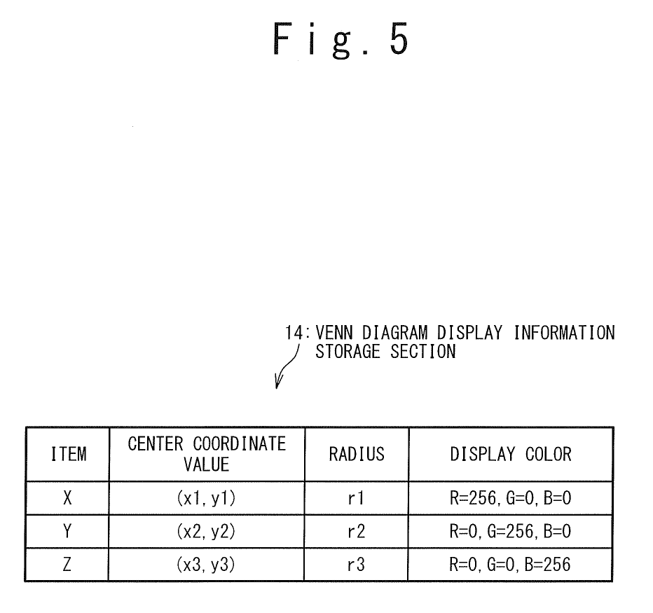

FIG. 5 is a view showing an example of contents stored in the Venn diagram display information storage section 14. This example shows a case where the Venn diagram display information for displaying the Venn diagram 220 is stored in the Venn diagram display information storage section 14 as shown in FIG. 4. The Venn diagram display information includes items, and the values of center coordinates, radiuses and display colors corresponding to those items.

The control section 11 has following functions.
A function of outputting an item selecting screen display instruction to the display controlling section 12 when the item selecting device 1 is started up.
A function of outputting a selecting item judging request including the coordinate values of the point on the Venn diagram 220 selected by a user to the selected item judging section 13, when a user performs an area selecting operation by designating the point.
A function of outputting, to the display controlling section 12, a selected item display instruction including a retuned item, when the item is received from the selected item judging section 13 in response to the selected item judging request.
A function of retaining the item received from the selected item judging section 13 in response to the selected item judging request.
A function of outputting the retained item to processing device means (not shown) that performs processing using that item, when the action button 24 is pushed. The processing means may be provided within or outside the item selecting device 1.

Selected items are registered to the selected item list storage section 15.

The selected item judging section 13 has a function of judging the selected items based on the items assigned within an area on the Venn diagram 220 selected by the user and the items that has already been selected by the user.

The selected item judging section 13 having the above mentioned functions includes area corresponding item judging section 131 and toggle section 132.

The area corresponding item judging section 131 has a function of judging all the items assigned in the area of the Venn diagram 220 selected by the user based on the contents stored in the Venn diagram display information storage section 14 and the coordinates included in a selected item judging request when the request is inputted from the control section 11.

The toggle section 132 has: a function of canceling an item from the selected item list storage section 15 when that item, which is included in the items judged by the area corresponding item judging section 131 as being selected, is registered to the selected item list storage section 15; a function of adding an item to the selected item list storage section 15 when that item, which is included in the items judged by the area corresponding item judging section 131 as being selected, is not registered to the selected item list storage section 15; and a function of returning information of the item that is already registered to the selected item list storage section 15 to the control section 11.

The item selecting device 1 can be realized by a computer. In this case, the item selecting device 1 can be realized in a following manner, for example. That is, a disk, a semiconductor memory, or other types of recording media to which a program for allowing a computer to function as the item selecting device 1 is recorded is provided so as to record the program read by the computer. Through controlling the operations of the computer itself in accordance with the program read out from the recording media, the computer can achieve the functions of the control section 11, the display controlling section 12, and the selected item judging section 13 on the computer itself.

### Explanation on Operations of Exemplary Embodiments

Next, operations of an embodiment of the present invention will be described in detail.

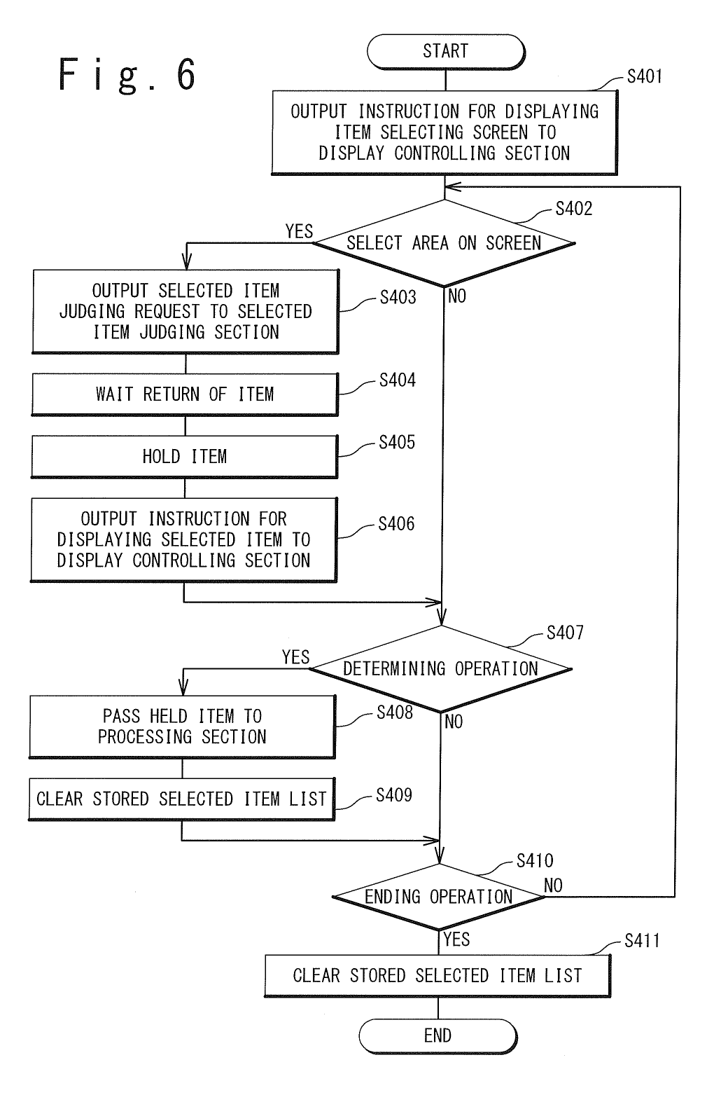

When the item selecting device 1 is started up by a user, the control section 11 provided within the item selecting device 1 outputs an instruction for displaying an item selecting screen to the display controlling section 12 as in a flowchart of FIG. 6 (step S401). With this operation, the display controlling section 12 displays the item selecting screen 21 as shown in FIG. 4 on the display 17. At that time, the display controlling section 12 displays the Venn diagram 220 as shown in FIG. 4 in the Venn diagram displaying area 22 according to the Venn diagram display information stored in the Venn diagram display information storage section 14 (see FIG. 5).

When the Venn diagram 220 as shown in FIG. 4 is displayed, the user selects, by using the input device 16, an area on the Venn diagram 220 which corresponds to the item the user wants to select. In this explanation, it is supposed that the user performs the area selecting operation by designating a point in the area 227 on the Venn diagram 220 to select the items “X and Y and Z”, for example. When the user performs the area selecting operation (YES in step S402), the control section 11 recognizes the coordinate values of the point designated by the user through the input device 16, and outputs a selected item judging request including the coordinate values to the selected item judging section 13 (step S403).

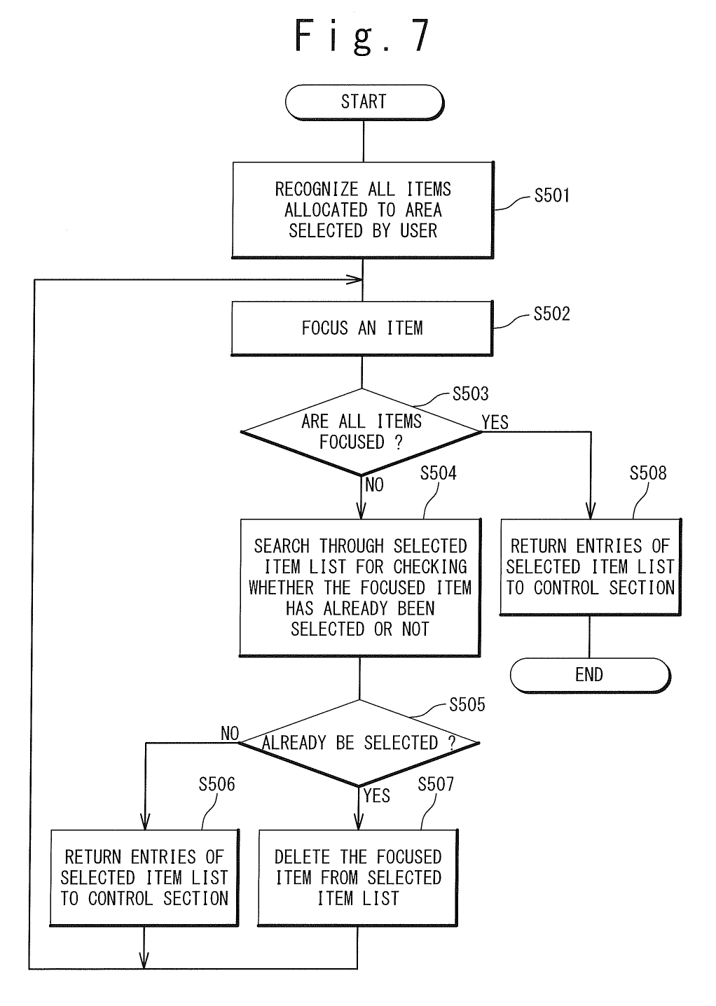

When the selected item judging request is inputted from the control section 11, as shown in a flowchart of FIG. 7, the area corresponding item judging section 131 within the selected item judging section 13 recognizes all the items that are assigned within the area 227 selected by the user, based on the coordinate values (coordinate values of the point within the area 227) included in the aforementioned request and the Venn diagram display information stored in the Venn diagram display information storage section 14 as shown in FIG. 5 (step S501).

More specifically, the processing of the step S501 is executed as follows. First, the area corresponding item judging section 131 inputs the identifier of the item “X”, center coordinate values (x1, y1), and the radius r1 from a first row of the Venn diagram display information storage section 14 shown in FIG. 5. Then, the area corresponding item judging section 131 recognizes the distance Δr between the point indicated by the center coordinate values (x1, y1) and the point indicated by the coordinate values included in the selected item judging request, and judges whether or not the distance Δr is equal to or smaller than the radius r1. That is, the area corresponding item judging section 131 judges whether or not the point designated by the user is a point inside a circle C1 that corresponds to the item X. Then, if the distance Δr is equal to or smaller than the radius r1, the area corresponding item judging section 131 judges that the item “X” is assigned within the area 227 that is selected by the user and, if the distance Δr is larger than the radius r1, the area corresponding item judging section 131 judges that the item “X” is not assigned within the area 227. Thereafter, the area corresponding item judging section 131 performs the same processing as that of the first row for the second, third, and fourth rows of the Venn diagram display information storage section 14 shown in FIG. 5. In the case of this example, the point on the area 227 selected by the user is a point within the circles C1, C2, and C3 corresponding respectively to the items X, Y, and Z. Thus, the area corresponding item judging section 131 judges that the items “X, Y, Z” are assigned within the area 227 that is selected by the user. These are the details of the processing executed in the step S501.

Thereafter, the toggle section 132 focuses one (the item “X”, for example) of the items “X, Y, Z” judged by the area corresponding item judging section 131 as items selected by the user (step S502), checks whether or not the focused item “X” is already registered to the selected item list storage section 15 to check if the focused item “X” is already selected by the user (step S504).

When it is judged that the item “X” is not yet selected (NO in step S505), the toggle section 132 additionally registers the item “X” to the selected item list storage section 15 (step S506) and focuses the next item thereafter (step S502). Meanwhile, when it is judged that the item “X” is already selected (YES in step S505), the toggle section 132 cancels the item “X” from the selected item list storage section 15(step S507) and focuses the next item thereafter (step S502). In the case of the present example, the selected item list storage section 15 is in a default state (cleared state), so that the item “X” is additionally registered to the selected item list storage section 15.

Thereafter, the toggle section 132 performs the same processing on the items “Y” and “Z”, and additionally registers the items “Y” and “Z” to the selected item list storage section 15. After completing the processing for all the items “X”, “Y”, and “Z” (YES in step S503), the toggle section 132 returns the information indicating the items “X”, “Y”, and “Z”, which are registered to the selected item list storage section 15, to the control section 11 (Step S508).

When the information indicating the items “X”, “Y”, “Z” are returned from the toggle section 132 (step S404 in FIG. 6), the control section 11 retains it at a storage part (not shown) which is provided inside thereof (step S405) and, thereafter, outputs a selected item display instruction including the information indicating the items “X”, “Y”, and “Z” to the display controlling section 12 (step S406). The display controlling section 12 displays the items “X”, “Y”, and “Z” as shown in FIG. 4 in the selected item displaying area 23 on the item selecting screen 21. The user looks the screen to recognize that the items “X”, “Y”, and “Z” are being selected currently.

When the user thinks that the items displayed on the screen is coincide with those the user want to select, the user operates the action button 24. When the operation to the selection button 24 is detected (YES in step S407 of FIG. 6), the controller means 11 reports the items “X”, “Y”, and “Z” stored in the storage part to the processing means (step S408) and clears the selected item list storage section 15 thereafter (step S409).

Meanwhile, for changing the contents of the selected items, the user performs a selecting operation of an area in accordance for changing the contents. For example, for changing the contents of the selected items from “X, Y, Z” to “X, Z”, the user performs an area selecting operation by designating one point within the area 222 on the Venn diagram 220.

When the area selecting operation designating one point within the area 222 is detected (YES in step S402 of FIG. 6), the control section 11 outputs a selected item judging request including the coordinate values of the designated point to the selected item judging section 13 (step S403).

When the selected item judging request is inputted from the control section 11, the area corresponding item judging section 131 of the selected item judging section 13 recognizes all the items assigned within the area 222 that is selected by the user (step S501 of FIG. 7). In the case of the present example, the area corresponding item judging section 131 recognizes the item “Y” as an item assigned within the area 222.

Thereafter, the toggle section 132 focuses the item “Y” obtained by the area corresponding item judging section 131, and checks whether or not the item “Y” is already registered to the selected item list storage section 15 to check if the attended item “Y” is already selected (step S502, S504). In the case of the present example, it is judged that the item “Y” is already selected since the items “X” “Y”, and “Z” are registered to the selected item list storage section 15.

If it is judged that the item “Y” is already selected (YES step S505), the toggle section 132 cancels the item “Y” from the selected item list storage section 15 (step S507) and, thereafter, returns the information indicating the items “X” and “Z” registered to the selected item list storage section 15 to the control section 11 (S508).

When the information indicating the items “X” and “Z” is returned (step S404 of FIG. 6), the control section 11 stores the information in the storage part that is provided inside thereof (step S405) and outputs a selected item display instruction including the information indicating the items “X” and “Z” to the display controlling section 12 (step S406). In response the outputted information, the display controlling section 12 displays the items “X” and “Z” included in the selected item instruction in the selected item displaying area 23 on the item selecting screen 21. By these processing, it is possible for the user to change the contents of the selected items easily.

The user operates the end button 25 on the item selecting screen 21 for ending the processing of the item selecting device 1. When it is detected that the end button 25 is operated (YES in step S410 of FIG. 6), the control section 11 clears the selected item list storage section 15 (step S411) and ends the processing.

Though the areas corresponding to the items “X”, “Y”, “Z” are shown with the circles C1, C2, C3 in the above explanation, those areas can be represented with other closed curves such as rectangles.

### First Example of Embodiments

Next, a first example of the above-described embodiment will be described. This example relates, for example, to a terminal unit for accepting order used in a restaurant, a fast food shop or the like, which is constituted with the item selecting device 1 of the above-described embodiment.

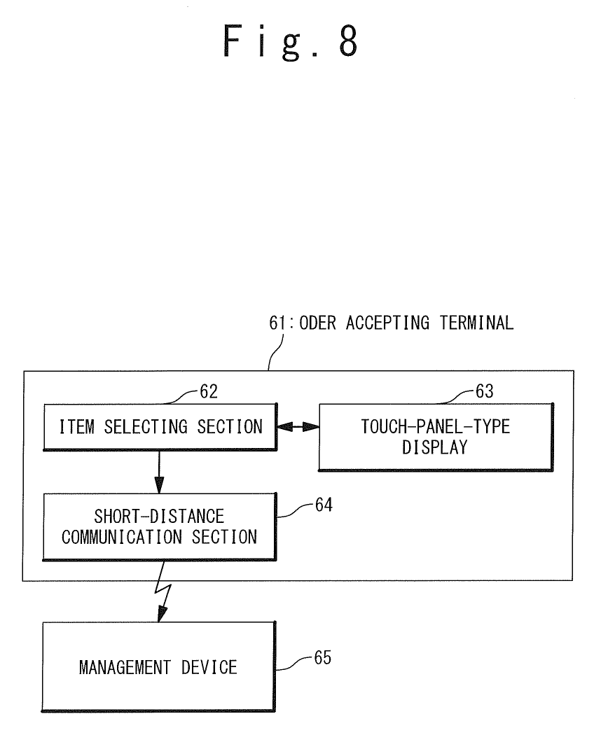

Referring to FIG. 8, an order accepting terminal 61 of a first example includes an item selecting section 62, a touch-panel-type display 63, and a short-distance communication section 64. The item selecting section 62 has the same structure as that of the item selecting device 1 shown in FIG. 3. However, instead of the input device 16 and the display 17, the touch-panel type display 63 is connected to the item selecting section 62.

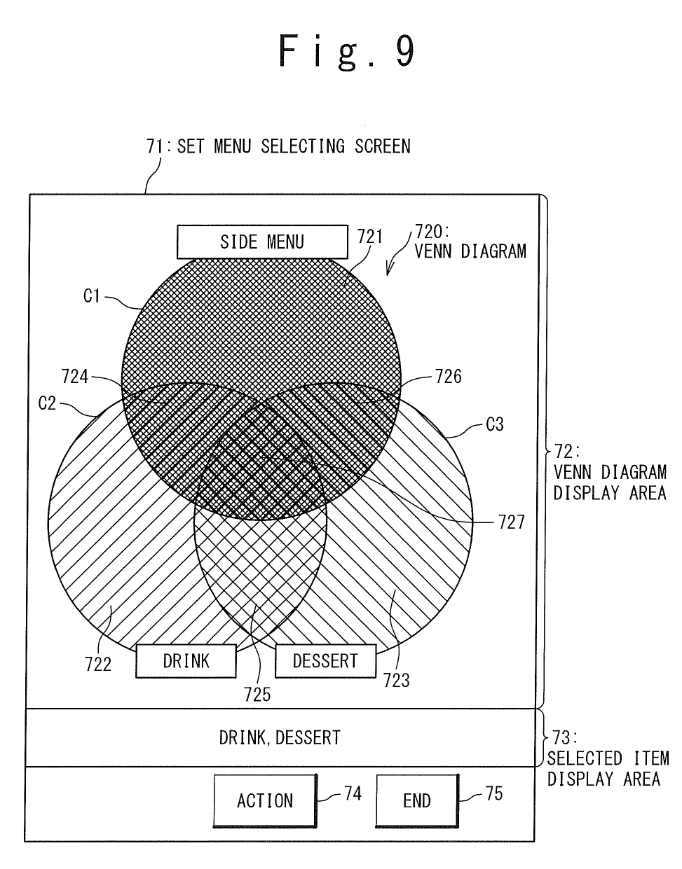

FIG. 9 is a view showing an example of a set menu selecting screen 71 that is displayed by the item selecting section 62 on the touch-panel-type display 61. A Venn diagram display area 72, a selected item display area 73, an action button 74, and an end button 75 which are icons of the Graphical User Interface are provided on the set menu selecting screen 71.

A Venn diagram 720 is displayed on the Venn diagram display area 72. On the Venn diagram, the summation of areas indicating items “side menu”, “drink”, and “dessert” is a universal set, and the areas “side menu”, “drink”, and “dessert” are subsets shown with circles C1, C2 and C3, respectively. The Venn diagram 720 is sectioned into areas 721, 722, 723 for corresponding to the items “side menu”, “drink”, “dessert”, areas 724, 725, 726 for corresponding to items “side menu and drink”, “drink and dessert”, “dessert and side menu”, and an area 727 for corresponding to “side menu, drink and dessert”.

The user selects a corresponding area on the Venn diagram 720 in accordance with the item to be selected. When an area on the Venn diagram 720 is selected by the user, the item selecting section 62 performs processing that is illustrated with the flowcharts of FIGS. 6 and 7 described above. Then, when the user operates the action button 74, the item selecting section 62 reports the selected items to the short-distance communication section 64 at that point.

The short-distance communication section 64 transmits the items reported from the item selecting section 62 to a management device 65. The management device 65 stores the items transmitted from the order accepting terminal device 61 in a storage device and displays the items on the display provided at a kitchen of the restaurant, for example.

In the example of FIG. 9, character strings such as “side menu”, “drink”, and “dessert” indicating the contents of the items are shown in the Venn diagram 720. However, icons indicating the contents of the items may be displayed instead. In such a case, the display controlling section 12 displays an the icon representing an item corresponding to a closed curve (a circle shown in FIG. 4) forming a part of the Venn diagram 220 and encompassing the icon in a position where a line constituting the Venn diagram is not overlapped to the icon.

### Second Example of Embodiments

Next, a second example of embodiments will be described. This example relates to a conferencing system that is constituted by utilizing the item selecting device 1 of above-described embodiments of the present invention.

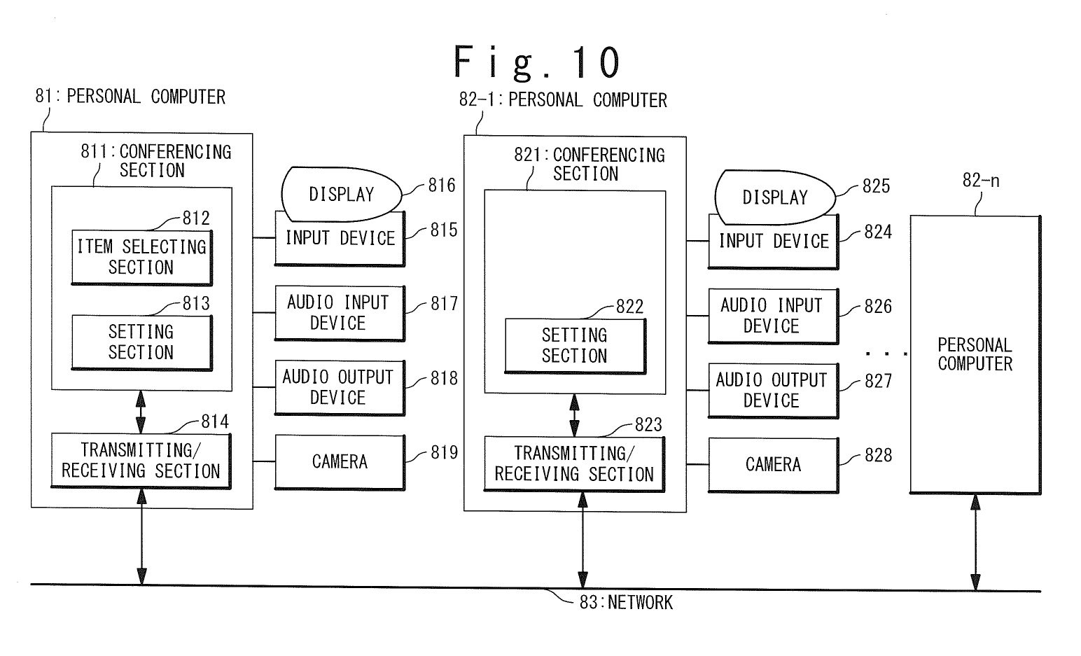

Referring to FIG. 10, the conferencing system of this example is constituted with a plurality of personal computers 81, 82-1-82-n. The personal computers 81, 82-1-82-n are connected to each other via a network 83 such as a LAN.

The personal computer 81 includes a conferencing section 811, a transmitting/receiving section 814, an input device 815, a display 816, an audio input device 817, an audio output device 818, and a camera 819.

The conferencing section 811 has three functions such as an “audio conferencing function”, “a video conferencing function”, and a “material sharing function”, and the user can arbitrarily select combinations of the functions to be used. The “audio conferencing function” is a function using audio communication for allowing a plurality of people existing in places far from each other to have on-line conversations. The “video conferencing function” is a function for enabling transmission of videos from cameras (web cameras) to members of the conference. The “material sharing function” is a function for allowing the members of the conference to share files stored on the personal computers as materials used in the on-line conference.

The conferencing section 811 includes an item selecting section 812 and a setting section 813. The item selecting section 812 has the same structure as that of the item selecting device 1 described before with reference to FIG. 3. The item selecting section 812 has a function of giving an instruction to the setting section 813 to set the functions selected by the user to be useable as well as informing the functions selected by the user to the other personal computers 82-1-82-n. The setting section 813 has a function of setting the functions indicated by the item selecting section 812 to be useable. The transmitting/receiving section 814 transmits and receives data via the network 83.

The personal computer 82-1 includes a conferencing section 821, a transmitting/receiving section 823, an input device 824, a display 825, an audio input device 826, an audio output device 827, and a camera 828.

The conferencing section 821 has three functions such as an “audio conferencing function”, “a video conferencing function”, and a “material sharing function”. The setting section 822 provided within the conferencing section 821 sets the functions informed by the personal computer 81 to be useable. The transmitting/receiving section 823 has a function of transmitting and receiving data via the network 83. The other personal computers 82-2-82-n also have the same structure as that of the personal computer 82-1.

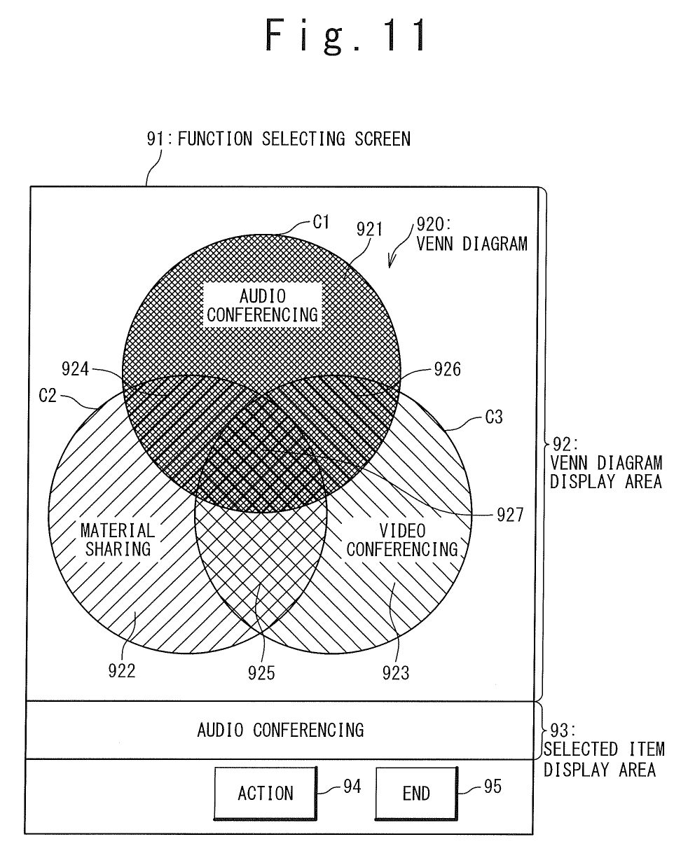

FIG. 11 is a view showing an example of a function selecting screen 91 that is displayed by the item selecting section 812 on the display 816. A Venn diagram display area 92, a selected item display area 93, an action button 94, and an end button 95 are provided on the function selecting screen 91.

A Venn diagram 920 is displayed on the Venn diagram display area 92. On the Venn diagram, the summation of areas indicating items “audio conferencing”, “material sharing”, and “video conferencing” is a universal set, ant the areas “audio conferencing”, “material sharing”, and “video conferencing” are subsets shown with circles C1, C2 and C3, respectively. The Venn diagram 920 is sectioned into areas 921, 922, 923 for corresponding to the items “audio conferencing”, “material sharing”, and “video conferencing”, areas 924, 925, 926 for corresponding to items “audio conferencing and material sharing”, “material sharing and video conferencing”, “video conferencing and audio conferencing”, and an area 927 for corresponding to “audio conferencing and material sharing and video conferencing”.

The user selects a corresponding area on the Venn diagram 920 in accordance with the item to be selected (the item indicating the function to be used). When an area on the Venn diagram 920 is selected by the user, the item selecting section 812 performs processing that is illustrated with the flowcharts of FIGS. 6 and 7 described above. Then, when the user operates the action button 94, the item selecting section 812 gives an instruction to the setting section 813 to set the selected function to be useable and informs the function to be used to each of the computers 82-1-82-n via the transmitting/receiving section 814 and the network 83. The setting section 822 of each of the personal computers 82-1-82-n set the function informed by the personal computer 81 to be useable.

### Effects of Exemplary Embodiments

According to above described embodiments of the present invention, the contents of the selected items can be changed by simple operations, so that the operability can be improved. For example, canceling an item from selected items and adding a new item to the selected items can be performed by simply selecting an area on the Venn diagram 220. This makes it possible to improve the operability. The reason for this is that the selected item judging section 13 recognizes all the pointed items assigned to the area on the Venn diagram 220 that is selected by a user through the input device 16, cancels the pointed items when there is an already-selected item within the pointed items, and adds the pointed items to the selected items when there is an item being not selected in the pointed items.

The present invention can be applied to a case where a sales clerk at a fast food restaurant or the like accepts orders of customers from a complicated set menu, for example. In addition, it can also be applied for selecting options of a system, for a questionnaire, for selecting options of a seat-reservation system, etc. Further, the present invention can be applied to more general-use purpose like an interface of an OS, a general application, a Web system.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

What is claimed is:

1. An item selecting device comprising:
a display controlling section configured to display a Venn diagram formed from a plurality of subsets each of which indicates a selectable item on a display screen, wherein each of a plurality of areas formed by the Venn diagram corresponds to an item group including at least one of the selectable item;
a control section configured to input information of a designated area selected from the plurality of areas by an input device; and
a selected item judging section configured to cancel a designated item which is each of elements of the item group corresponding to the designated area from a selected item list when the designated item is set as an item already selected, and to add the designated item to the selected item list when the designated item is not set as an item already selected.

2. The item selecting device according to claim 1, further comprising:
a selected item list storage section configured to store the selected item list,
wherein the selected item judging section judges whether the designated item is already selected or not by referring the selected item list storage section.

3. The item selecting device according to claim 2, wherein the selected item judging section includes:
an area corresponding item judging section configured to recognize one or more all items corresponding to the designated area, wherein each of the all items is the designated item; and
a toggle section configured to cancel the designated item from the selected item list when the designated item is stored in the selected item list, and to add the designated item to the selected item list when the designated item is not stored in the selected item list.

4. The item selecting device according to claim 3, wherein the area corresponding item judging section set at least one item corresponding to an area formed by a surrounding closed curve selected by the input device as the all items.

5. The item selecting device according to claim 1, wherein the display controlling section displays an icon representing an item corresponding to a closed curve forming a part of the Venn diagram and encompassing the icon in a position where a line constituting the Venn diagram is not overlapped.

6. An item selecting method comprising:
a computer displaying a Venn diagram formed from a plurality of subsets each of which indicates a selectable item on a display screen, wherein each of a plurality of areas formed by the Venn diagram corresponds to an item group including at least one of the selectable item;
a computer inputting information of a designated area selected from the plurality of areas by an input device; and
judging a selected item, wherein the judging includes:
a computer canceling a designated item which is each of elements of the item group corresponding to the designated area from a selected item list when the designated item is set as an item already selected; and
a computer adding the designated item to the selected item list when the designated item is not set as an item already selected.

7. The item selecting method according to claim 6, wherein the computer includes a selected item list storage section storing a selected item list, and
at the judging, it is judged that whether the designated item is already selected or not by referring the selected item list storage section for the canceling or the adding.

8. The item selecting method according to claim 7, wherein the judging includes:
recognizing one or more all items corresponding to the designated area, wherein each of the all items is the designated item;
canceling the designated item from the selected item list when the designated item is stored in the selected item list; and
adding the designated item to the selected item list when the designated item is not stored in the selected item list.

9. A computer program product embodied on a computer-readable medium and comprising code that, when executed, causes a computer to perform the following:
a computer displaying a Venn diagram formed from a plurality of subsets each of which indicates a selectable item on a display screen, wherein each of a plurality of areas formed by the Venn diagram corresponds to an item group including at least one of the selectable item;
inputting information of a designated area selected from the plurality of areas by an input device; and
judging a selected item, wherein the judging includes:
canceling a designated item which is each of elements of the item group corresponding to the designated area from a selected item list when the designated item is set as an item already selected; and
adding the designated item to the selected item list when the designated item is not set as an item already selected.

10. The computer program product according to claim 9, wherein a storage section of the computer stores a selected item list, and
at the judging, it is judged that whether the designated item is already selected or not by referring the selected item list storage section for the canceling or the adding.

11. The computer program product according to claim 10, wherein the judging includes:
recognizing one or more all items corresponding to the designated area, wherein each of the all items is the designated item;
canceling the designated item from the selected item list when the designated item is stored in the selected item list; and
adding the designated item to the selected item list when the designated item is not stored in the selected item list.
